(19) United States
(12) Patent Application Publication
(10) Pub. No.: US 2011/0052343 A1
(43) Pub. Date: Mar. 3, 2011

(54) FASTENING ELEMENT AND METHOD FOR PRODUCING A FASTENING ELEMENT

(75) Inventor: Frank SCHMIDT, Muenchen (DE)

(73) Assignee: Hilti Aktiengesellschaft, Schaan (LI)

(21) Appl. No.: 12/873,960

(22) Filed: Sep. 1, 2010

(30) Foreign Application Priority Data
Sep. 3, 2009 (DE) 10 2009 039 919.4

(51) Int. Cl. F16B 13/12; B23P 17/04

(52) U.S. Cl. 411/57.1; 29/428

(57) ABSTRACT

A fastening element and a method for producing a fastening element is disclosed. The fastening element includes an elongated base body and a connecting sleeve on one end of the base body, which features a connecting section for a prestressing element. The connecting sleeve is fixed on the base body by rolling.

This application claims the priority of German Patent Document No. 10 2009 039 919.4, filed Sep. 3, 2009, the disclosure of which is expressly incorporated by reference herein.

### BACKGROUND AND SUMMARY OF THE INVENTION

The invention relates to a fastening element, in particular for use in mining and tunnel construction or for stabilizing slopes and embankments. The invention also relates to a method for producing a fastening element.

In mining and tunnel construction, ceilings and side walls are secured by means of chemically or mechanically anchored fastening elements. These types of fastening elements are also called rock bolts or rock anchors. These fastening elements are also suitable for stabilizing slopes and embankments in order to prevent, for example, a slippage of material. These types of fastening elements are called soil nails, for example.

A generic fastening element is known from U.S. Pat. No. 2,725,843, which has an outer thread configured directly on the base body as a connecting section for a prestressing element, such as a threaded nut, on a free end of the elongated base body when in a driven-in state. The fastening element anchored in the substrate is prestressed by means of the prestressing element. The prestressing element may also be used only to hold an additional securing means, such as for example, a safety net to ensure against falling pieces of material or to reinforce, for example, subsequently applied sprayed concrete. In this application of the fastening element, no prestressing is applied to the fastening element.

The disadvantage of the known attainment is that, depending upon the type, shape or material of the base body, a formation of the connecting section for a prestressing element directly on the base body is not possible or is only possible with great effort.

A generic fastening element is known from European Patent Document No. EP 0 188 174 A1, in which a connecting sleeve with a connecting section for the prestressing element is adhesively bonded on the free end of the elongated base body.

The disadvantage of this known attainment is that loads required for securing purposes, e.g., in underground mining, are only transmittable via an adhesive bond in a conditional manner. In addition, the quality of the adhesive bond is dependent upon a multitude of conditions which cannot always be controlled to the desired degree so that a great safety factor must be taken into account when using the fastening element. As a result of this, these fastening elements are over-dimensioned for the most part. Furthermore, to achieve adequate securing in comparison with conventional fastening elements, such as those known from U.S. Pat. No. 2,725,843 for example, a greater number of fastening elements are required, which substantially raises the costs of providing the securing.

The object of the invention is creating a fastening element particularly for use in mining and tunnel construction or for stabilizing slopes and embankments that does not possess the aforementioned disadvantages and is especially simple to manufacture and also features a high level of reliability of the connection between the connecting sleeve and the elongated base body. It is also the object of the invention to create a method for producing such a fastening element.

According to the invention, the connecting sleeve is fixed on the base body by rolling.

During rolling, the connecting sleeve is fixed in a simple manner at least in a force-fit on the base body. The connecting sleeve may thereby be fixed securely on the base body independent of the design of the outer wall of the base body. The length of the deformed connecting sleeve defines the transmittable load.

The connecting sleeve may have the connecting section for the prestressing element already before the rolling process for fixing the connecting sleeve on the base body. Alternatively, the connecting means and/or the connecting section for the prestressing element are formed during the rolling process for fixing the connecting sleeve on the base body.

The elongated base body forms the supporting element of the fastening element and may be formed from, for example, a rod-shaped element, or from several elements, such as for example, individual rods or strands, that are advantageously connected to each other. In addition to a circular cross-section, the base body may also have a cross-section that deviates therefrom.

The fastening element is anchored in the substrate, for example, chemically by means of a hardenable compound and may have a design of the outer wall that is advantageous for this on the end that is opposite from the end with the connecting sleeve. As an alternative to this, or in combination with a chemical anchoring, a mechanical anchoring mechanism, e.g., a spreading or clamping mechanism, is provided, for example, on the end that is opposite from the connecting sleeve for mechanically anchoring the fastening element in the substrate.

The connecting sleeve is preferably only partially fixed on the base body, whereby a connecting sleeve with a special design, e.g., with differently designed and/or prefabricated sections, may also be fixed simply on the base body. The connecting sleeve has, for example, at least one section that is deformable by milling or rolling and attached thereto is at least one other section, which is provided, for example, with a special design, e.g., with respect to its outer contour or its material thickness. The length of the one or more deformed sections is selected in accordance with the loads to be transmitted via the rolled connection. The greater the total length of the deformed sections of the connecting sleeve fixed on the base body, the greater the contact surface is between the connecting sleeve and the base body, via which forces are transmittable. The total deformed length, therefore, defines the maximum permissible loading capacity of the fastening element and is selected accordingly.

The connecting section of the connecting sleeve preferably has an external thread, especially advantageously an external thread in a metric or inch format, for connecting a threaded nut as a prestressing element to an internal thread corresponding to the design of the external thread. Alternatively, the connecting section is configured as a bayonet connection or a snap-on connection, on which a correspondingly configured prestressing element can be arranged.

The base body preferably has an outer profiling, whereby, in addition to a force fit, a positive fit is established between the base body and the outer sleeve when fixing the connecting sleeve on the base body by rolling. The positive-fit connection allows greater forces to be transmitted than a force-fit connection.

The base body is preferably configured to be tubular, and a hardenable compound, for example, may be injected through its interior space into the drill hole. A prefabricated compound may also be provided in this cavity, which may be output from the base body by means of a suitable ejecting device. In the case of a self-drilling fastening element, which has for example a drill head on the end that is opposite from the end with the connecting sleeve, rinse water may be supplied to the drill head through the tubular base body during the drilling process so that drill debris and drill dust that develops when drilling may be discharged through the tubular base body.

The base body is preferably fabricated of a glass-fiber reinforced plastic (GFRP), whereby the fastening element has a low weight as compared to a base body made of steel and can be used in a versatile manner. Because of the rolled-on connecting sleeve, no special requirements are placed on the design of the outer wall of the base body made of a glass-fiber reinforced plastic with respect to connectability of the base body to the connecting sleeve.

The method according to the invention for producing a fastening element with an elongated base body and a connecting sleeve comprises the following steps.

Sliding a sleeve body over one end of the base body of the fastening element and deforming the sleeve body by means of rollers of a rolling machine to fix the sleeve body frictionally and/or with a positive fit and to form the connecting sleeve on the base body.

The sleeve body is deformed at least over a region of its length. The sleeve body is advantageously deformed over its entire length so that the largest possible contact surface is available between the sleeve body or the connecting sleeve and the base body for transmitting loads.

This method may be executed simply and independent of, for example, the design of the outer wall and/or of the material of the base body. It is unnecessary to take specific materials or material combinations into consideration, such as those that must be taken into account, for example, with a sleeve body fixed on the base body by welding. A suitable rolling process is selected as a function of the deformability of the sleeve body material and corresponding rollers or cylinders.

When deforming the sleeve body, the connecting section of the connecting sleeve is simultaneously applied to the outer side of the sleeve body, whereby the fixing of the sleeve body and forming of the connecting section may take place in one rolling step. Alternatively, the sleeve body is fixed on the base body first and then, in another rolling step, the connecting section of the connecting sleeve is formed on the outer side of the sleeve body. An external thread is advantageously applied to the outer side of the sleeve body, and the thread forms the connecting section of the connecting sleeve. The surface coming into contact with the sleeve body or the deformation region of the rolling or the milling is formed in accordance with the connecting means being created, e.g., an external thread in a metric or inch format.

A sleeve body is preferably used whose inside diameter corresponds at least to the maximum outside diameter of the base body, whereby the sleeve body may be slid onto the base body in a simple manner. A sleeve body is advantageously used whose inside diameter is slightly larger than the maximum outside diameter of the base body. The inside diameter of the sleeve body corresponds in this case advantageously to 1.05 times to 1.2 times the maximum outside diameter of the base body.

The invention will be explained in greater detail in the following on the basis of exemplary embodiments.

### BRIEF DESCRIPTION OF THE DRAWINGS

FIG. 1 is a side view of a fastening element;

FIG. 2 is a section through the fastening element along Line II-II in FIG. 1;

FIG. 3 is a side view of a second exemplary embodiment of a fastening element; and

FIGS. 4 A and 4B illustrate a method for producing a fastening element in two partial steps, each shown in a side view.

### DETAILED DESCRIPTION OF THE DRAWINGS

As a rule, in the figures the same parts are identified with the same reference numbers.

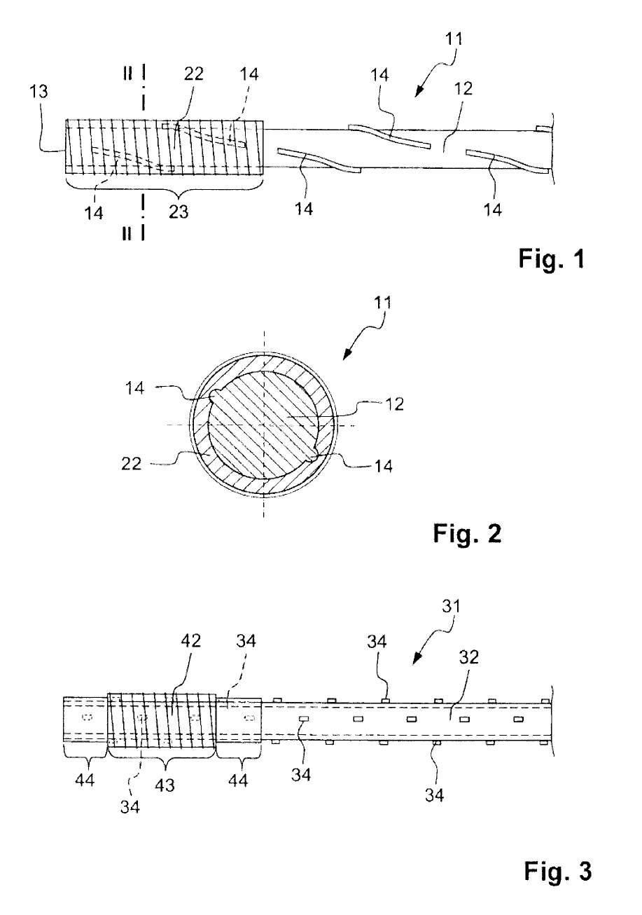

The fastening element 11 depicted in FIGS. 1 and 2 has an elongated base body 12 and a connecting sleeve 22 on one end 13 of the base body 12, which has a connecting section 23 for a prestressing element. The connecting section 23 of the connecting sleeve 22 features an external thread.

The connecting sleeve 22 is fixed by rolling on the base body 12, which has an outer profiling 14. The base body 12 in this example is fabricated of a glass-fiber reinforced plastic.

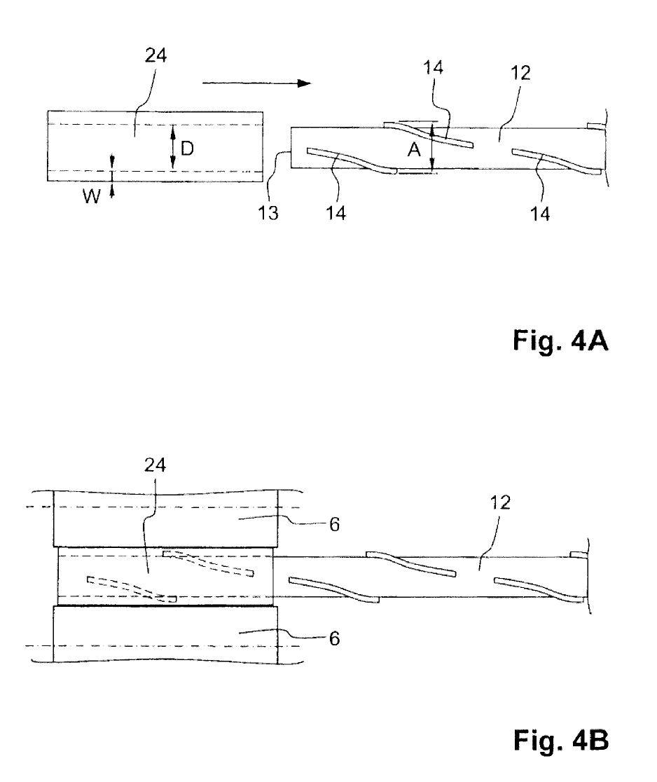

The method according to the invention for producing the fastening element 11 will be explained in the following (FIGS. 4A and 4B).

First a sleeve body 24 forming the connecting sleeve 22 and made of a deformable material is slid over the end 13 of the base body 12. The sleeve body 24 is fabricated, for example, of steel and advantageously has a wall thickness W of 1 mm to 4 mm, advantageously of 1.5 mm to 2.5 mm. In addition, the sleeve body 24 has an inside diameter D which is at least equally as large as the maximum outside diameter A of the base body 12. To simply slide the sleeve body 24 on the base body 12, the inside diameter D of the sleeve body 24 in this exemplary embodiment corresponds to 1.1 times the maximum outside diameter A of the base body 12, whereby this inside diameter D of the sleeve body 24 is slightly larger than the maximum outside diameter A of the base body 12.

Then, using, for example, opposing rollers 6 of a rolling machine (not shown here in greater detail), the sleeve body 24 is deformed to fix the sleeve body 24 on the base body 12 frictionally and/or with a positive-fit. When deforming the sleeve body 24, an external thread is simultaneously applied to the outer side of the sleeve body 24, and the thread forms the connecting section 23 of the connecting sleeve 22.

The result of the method is a fastening element 11 with a connecting sleeve 22 fixed on the base body 12 by rolling as depicted in FIGS. 1 and 2.

The fastening element 31 depicted in FIG. 3 differs from the previously explained fastening element 11 in terms of the design of the base body 32 and the connecting sleeve 42.

The base body 32 is tubular and features a different type of outer profiling 34 as compared to the base body 12 of the fastening element 11. In addition, this base body 12 is fabricated of steel in this exemplary embodiment.

The connecting sleeve 42 in this case is only partially fixed on the base body 32 by rolling at two fixing sections 44 that are spaced apart from one another. A connecting section 43 of the connecting sleeve 42 featuring an external thread is provided between the two fixing sections 44.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fastening element, comprising:
an elongated base body; and
a connecting sleeve disposed on an end of the base body, wherein the connecting sleeve includes a connecting section for a prestressing element and wherein the connecting sleeve is fixed on the base body by rolling.

2. The fastening element according to claim 1, wherein the connecting sleeve is only partially fixed on the base body.

3. The fastening element according to claim 1, wherein the connecting section has an external thread.

4. The fastening element according to claim 1, wherein the base body has an outer profiling.

5. The fastening element according to claim 1, wherein the base body is tubular.

6. The fastening element according to claim 1, wherein the base body is fabricated of a glass-fiber reinforced plastic.

7. A method for producing a fastening element, comprising the steps of:
sliding a sleeve body over an end of a base body; and
deforming the sleeve body by rollers of a rolling machine, wherein the step of deforming fixes the sleeve body frictionally and/or with a positive-fit on the base body and forms the sleeve body as a connecting sleeve on the base body.

8. The method according to claim 7, wherein the step of deforming simultaneously applies a connecting section of the connecting sleeve to an outer side of the sleeve body.

9. The method according to claim 7, wherein the sleeve body has an inside diameter that corresponds to at least a maximum outside diameter of the base body.
